(19) United States
(12) Patent Application Publication
(10) Pub. No.: US 2014/0215094 A1
(43) Pub. Date: Jul. 31, 2014

(54) METHOD AND SYSTEM FOR DATA COMPRESSION

(71) Applicant: Anders NORDIN, Bandhagen (SE)

(72) Inventor: Anders NORDIN, Bandhagen (SE)

(21) Appl. No.: 13/800,420

(22) Filed: Mar. 13, 2013

(30) Foreign Application Priority Data
Jan. 29, 2013 (SE) 1350093-9

(51) Int. Cl. H04L 29/06

(52) U.S. Cl. CPC H04L 69/04
USPC 709/247

(57) ABSTRACT

Interrelated methods for compression and decompression within a common context provides mapping of each index of a sequence of indexes to an index value. The method comprises decomposing a data set into a sequence of chunks, wherein each chunk is associated with a bit pattern and an index unique within the sequence. For a certain bit pattern a value sum is created of all index values mapped to each index of every chunk associated with the bit pattern. The decompression method comprises retrieving a value sum associated with a certain bit pattern; selecting a set of indexes, such that the sum of all index values mapped to indexes comprised in the selected set of indexes equals the retrieved index value sum; and recomposing a sequence of chunks such that each chunk is further associated with the unique bit pattern.

### TECHNICAL FIELD

The present invention relates to compression of data for storing in a node and reducing data traffic between two nodes comprised in a data communications network.

### BACKGROUND

A backbone network is a part of computer network infrastructure that interconnects various pieces of network, providing a path for the exchange of data between different Local Area Networks, LANs, or sub-networks, which may be wired or wireless. A backbone network may tie together networks within a limited area or over a wide area. Normally, the backbone's capacity is greater than those of the networks connected to it. The capacity of a backbone network is determined by the technology on which it is based and the capacity of the transmission equipment installed on the network.

The Internet is a conglomeration of multiple, redundant backbone networks, each owned by a separate party. It is typically a fiber optic trunk line consisting of many fiber optic cables bundled together to increase the capacity.

Even so, limited capacity in the network backbone is increasingly becoming a problem, especially in parts of the world where development or rollout of backbone technology is lagging, due to for instance infrastructural or topological challenges, or lack of financial means. Limited backbone capacity e.g. may create a bottleneck in the rollout of high-bandwidth services and in the upgrading of cellular networks to provide value-added services.

Another problem is related to limited storage space available on a computer hard drive. Even the largest data storage has its limitations.

In order to send data from one computer to another over a network, such as the Internet, the nodes comprised in the network must be able to communicate. This is enabled through a set of rules that regulate how the communication should be performed. One example is how the TCP/IP protocols provide such rules for the Internet.

Below follows an example of the present art applied in a Wide Area Network, WAN. A first user is connected via a first computer to a first Local Area Network, LAN. The first LAN is interconnected with a second LAN via the WAN. The second user is connected to the second LAN via a second computer.

If a first user wants to send a data file to the second user, the first user's computer retrieves the data file from some local storage, transforms it into streamable data destined for the second computer, labeled with an address. The data stream is then sent out on the first LAN. When the data stream reaches the first WAN router, in the backbone network, the first WAN router performs a routing procedure in order to find out how to send the data stream on its way to the intended destination. Ideally, the WAN Router should select the fastest and most efficient route through the WAN. When the routing procedure has been performed, the data stream will have received additional addressing instructions/labels, most likely including the address to an intermittent router in the path to the second WAN router.

When the datastream has reached the second WAN router, the datastream is routed into and through the second Local Area Network until it reaches the second computer, the destination computer. At the destination, the data stream is being converted to the format of the original data file using the same protocol that it was initially fragmented with, upon which it can be presented to the second user, as the first user intended.

The known compression methods usually operate on the frames, compressing addresses and the like, but usually leave the payload intact, since the data representation must appear at the destination in its original content and sequence in order for it to be presented to the second user as intended.

It would be advantageous to be able to provide a solution to the limited transmission capacity in the backbone network, and further, it would be advantageous to provide a solution to the problem of limited storage space on hard drives of computers, such as e.g. user terminals or network routers or servers that are part of the backbone network, or a sub network connected to the backbone network.

### SUMMARY

It is the object of the present invention to obviate at least some of the above advantages and provide improved methods, apparatuses and computer media products avoiding the above mentioned drawbacks.

### BRIEF DESCRIPTION OF THE DRAWINGS

Embodiments of the present invention will be described in detail below with reference to the accompanying drawings, in which

FIG. 1 is a schematic view of a communications system in which methods according to the present invention may be performed.

FIGS. 2, 3 and 4 illustrate certain properties of data upon which methods according to the present invention may operate.

FIG. 5 illustrates the concept of index bins according to features of the present inventions.

FIG. 6 is a flow-chart illustrating methods according to the present invention.

### DETAILED DESCRIPTION

The solution according to the present invention is an interrelated set of methods for data compression and decompression. In exemplary embodiments of the method according to the present invention, the data compression and decompression is performed in a Network Interface layer in a TCP/IP stack.

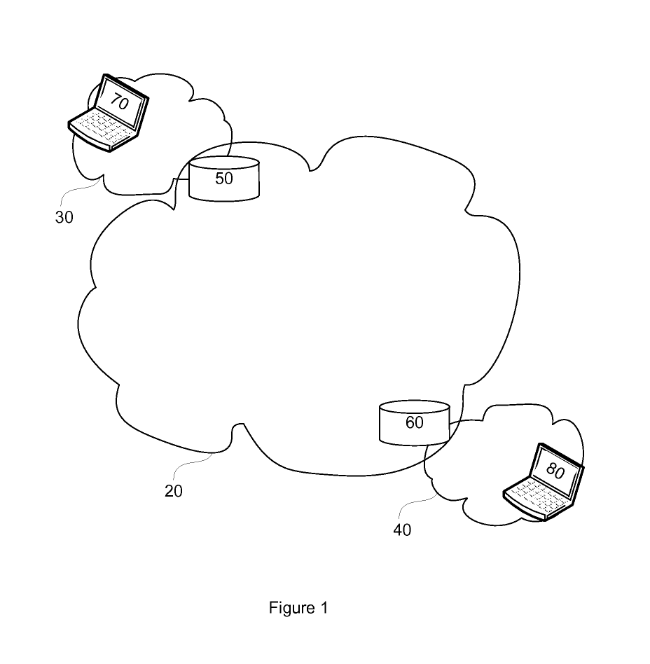

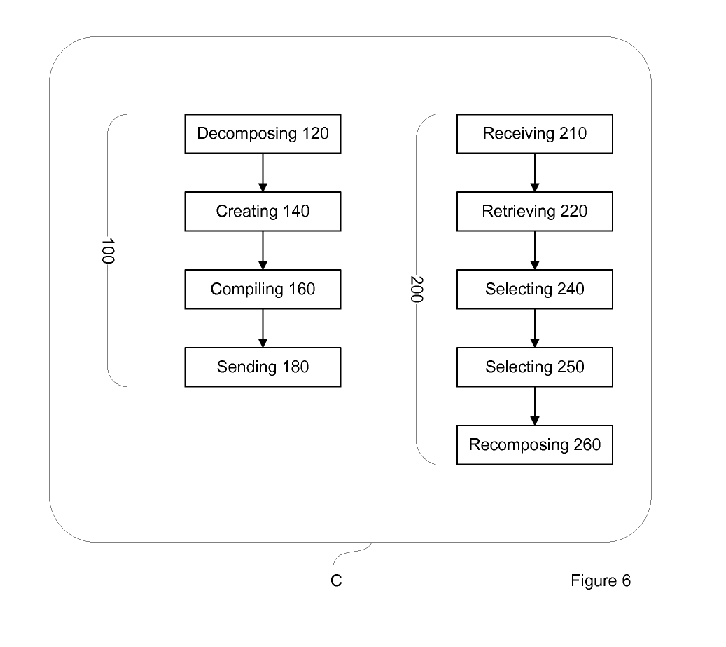

With reference to FIGS. 1 and 6, a first aspect of the invention is a method 100 for compression of data. The compression of data is performed within a common context C providing a mapping of each index iₖ of a sequence of indexes to an index value Vₖ. The method 100 of the first aspect comprises decomposing 120 a data set D into a sequence of chunks d, wherein each chunk d is associated with a bit pattern p and an index i unique within the sequence. The method 100 of the first aspect further comprises creating 140, for a certain bit pattern pₓ, a value sum Sₓ of all index values mapped to each index of every chunk associated with the bit pattern pₓ, wherein the value sum Sₓ is a component of a compressed representation of the data set D. Each chunk d is of a predetermined bit length l.

According to the method 100 of the first aspect, the creating 140 step is repeated for each bit pattern p of a set of bit patterns. The set of bit patterns may either comprise all bit patterns that may potentially occur in a chunk of bit length l. Alternatively, the set of bit patterns may comprise only the bit patterns actually featured in the sequence of chunks.

The method of the first aspect may further comprise a step of compiling 160 a list of value sums comprising each created value sum.

The method 100 of the first aspect may be performed in a first network server and may comprise the further step sending 180 the value sum Sₓ to a second network server.

A second aspect of the invention is a method 200 interrelated to the method 100 of the first aspect.

The method 200 of the second aspect is a method for decompression within a common context C providing mapping of each index iₖ of a sequence of indexes to an index value Vₖ. The method of the second aspect comprises the steps

retrieving 220 a value sum Sₓ, associated with a certain bit pattern pₓ; selecting 240 a set of indexes bₓ, such that the sum of all index values mapped to indexes comprised in the selected set of indexes bₓ equals the retrieved index value sum Sₓ; and
recomposing 260 a sequence of chunks such that each chunk associated with a selected index of the set of indexes bₓ is further associated with the unique bit pattern.

The method 200 of the second aspect may be performed in a second network server, and may comprise the further step receiving the value sum Sₓ from a first network server.

The retrieving 220, selecting 240 and recomposing 260 steps of the second aspect 200 may be repeated for each value sum of a list of value sums.

The selecting step 240 of the second aspect 200 may further comprise selecting an index 250 if its associated index value is smaller than a current value difference dV. The selecting an index 250 step may be repeated for indexes in a bottom-to-top order.

According to the method 200 of the second aspect, the current value difference dV may be equal to the difference between the retrieved index value sum Sₓ and a sum of each associated index value of each previously selected index.

In methods 100, 200 of the first and second aspects of the invention, the common context C provides mapping between an index i and an index value V, such that each index value Vₖ is larger than a sum of all index values mapped to a subset of consecutive indexes comprising the top index and the upper adjacent index Vₖ₋₁ in the sequence of indexes.

Further, according to the first and second aspects 100, 200 of the invention, an initiation of the common context C comprises mapping indexes in increasing top-to bottom order.

The common context C comprises a predefined listing order of value sums, such that the position of each value sum Sₓ in the list indicates the associated bit pattern pₓ.

A third aspect of the invention is a network server 50 adapted to perform the method steps of the first aspect 100 of the invention.

A fourth aspect of the invention is an interrelated network server 60 adapted to perform the method steps of the second aspect 200 of the invention.

A fifth aspect of the invention is a computer program comprising program instructions for causing a computer to perform the process of the first or second aspects 100, 200 of the invention when said product is run on a computer. The computer program of the fifth aspect of the invention may be embodied on a record medium, stored in a computer memory, embodied in a read-only memory, or carried on an electrical carrier signal.

A sixth aspect of the invention is a computer program product comprising a computer readable medium, having thereon: computer program code means, when said program is loaded, to make the computer execute the process of the first or second aspect 100, 200 of the invention.

The compression and decompression methods 100, 200 according to the present invention may be performed in a single node, e.g. in order to compress data locally for reducing storing needs, or for compressing data to be sent from a first node to a second node. Methods according to the present invention may be implemented in an exemplary communication system 10 as illustrated by FIG. 1. The exemplary communications system 10 comprises a wide area network 20, WAN, alternatively referred to as a backbone network 20, or backbone 20. Further comprised in the communications system 10, and interconnected with the backbone 20 through gateways (not shown in the figure), is a first local area network 30, LAN, and a second LAN 40. The first and second LANs 30, 40, may communicate via the backbone 20 to which they are both connected.

A communications system 10 according to embodiments of the present invention relies on a common context C. The context C is defined by a set of parameters comprising an index table. As a measure to initiate a system for compression, such an index table is set up.

In an exemplary embodiment of the present invention, an index table is set up as shown in the exemplary Table 1 below. Table 1 features 16 rows indexed from 0 to 15 in a first column. Indexes of the first column is mapped to, and thereby associated with, a dimensionless value, an index value Vᵢ, in a second column.

TABLE 1

| Index, i | Index value, Vᵢ |
|---|---|
| 0 | 1 |
| 1 | 2 |
| 2 | 4 |
| 3 | 8 |
| 4 | 16 |
| 5 | 32 |
| 6 | 64 |
| 7 | 128 |
| 8 | 256 |
| 9 | 512 |
| 10 | 1024 |
| 11 | 2048 |
| 12 | 4096 |
| 13 | 8192 |
| 14 | 16384 |
| 15 | 32768 |

The significant property of the indexes i is that they are ordinal numbers denoting relative position in a sequence with two extreme ends, where one extreme end is defined as the top index and the other extreme end is defined as the bottom index.

The significant property of the index values is that the magnitude of each index value Vₖ is larger than the sum of upper index values, e.g. all index values mapped to indexes in the top-most part of the table immediately above of Vₖ. The difference, or offset Δ, between the sum of previous index values and a current index value is constant.

V₀≡Δ, Equation 1

Vₖ=Δ+Σₙ₌₁^{k}Vₙ₋₁ Equation 2

In the present example, the offset Δ equals 1.

In the example in table 1, the top index is 0. In other embodiments, the top index could be set to 1 or −1 or some other number, positive or negative. Further, though the top-to-bottom progression according to the above example moves from smaller indexes to larger indexes, in other embodiments, the top-to-bottom progression may be from larger to smaller indexes.

The properties of the indexing scheme, such as top and bottom indexes, direction of progression etc. may also be part of the common context C.

The table can be setup in various ways, as long as it is present and accessible in the common context C during performing the compression and decompression. If the compression and decompression is performed in different nodes, two identical tables should be initiated in the respective nodes. The table can be created in one place and then distributed two other nodes after creation, or it can be created locally in the different nodes, as long as the resulting index tables are identical.

Exemplary embodiments of a compression method 100 and a decompression method 200 according to the present invention are illustrated in FIG. 6. We will now continue to describe a compression method 100 according to one embodiment of the present invention, in relation to an exemplary communications system 10 comprising two nodes 50, 60 in a backbone network 20.

The two nodes are network servers in the backbone 20, and have been initiated such that they share a common context C, comprising the mapping table as described above.

The first node 50 may receive an amount of data in the form of a data stream from some other node in the communication network. For instance data may have been sent from a laptop 70 in the LAN 30. Alternatively, data may be retrieved from an internal storage, and the data is then decomposed such that further processing can be made.

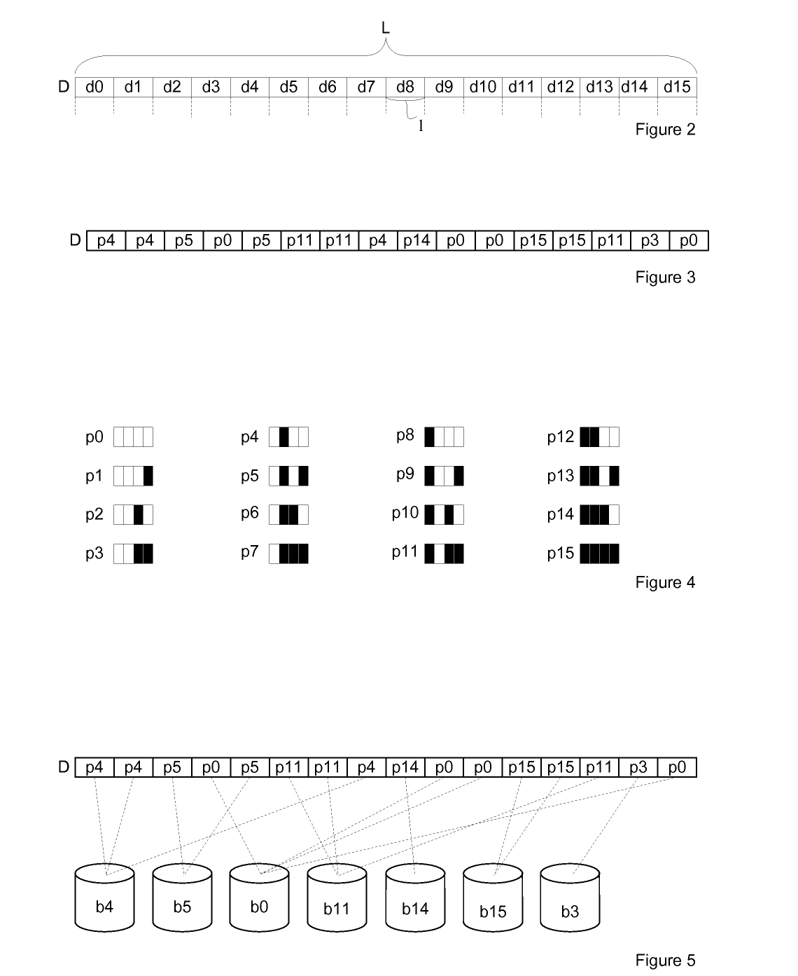

With reference to FIG. 2, the first node 50 retrieves a predefined amount of data representing a data stream D of a bit length L. The data stream D will now be decomposed, to enable parsing and further processing of the data.

As illustrated in FIG. 2, the data stream D is partitioned, as indicated by the dotted lines, into a sequence of smaller data chunks d of a predetermined bit length l. Each data chunk is associated with an index that is unique to the sequence, e.g. it is indexed according to the index scheme of the index table, e.g. dᵢ. In the present example, as the index table features 16 indexes, the predetermined bit length is 4 bits.

In the general case where l is the bit length and N is the number of indexes, the following applies:

$$\begin{matrix}l = \sqrt[2]{N} , & Equation 3 \\ D = N * l & Equation 4\end{matrix}$$

Each chunk d features, and is therefore inherently associated to, a certain bit pattern p, as exemplified in FIG. 3. In the present example with a bit length l=4, a chunk may feature any one of 16 bit patterns p₀-p₁₅, as exemplified in FIG. 4, where the white areas could represent “zeros” and the black areas the complementary “ones”. In this example, the bit patterns are direct representations of their reference numbers x in a binary representation. Any coding scheme could be used to link bit patterns pₓ to reference numbers x. The scheme illustrated in FIG. 4 is according to exemplary embodiments.

In a next step, a value sum Sₓ is created for each bit pattern pₓ. Each created value sum Sₓ is a component of a compressed representation of the data set D.

In order to create each value sum Sₓ the chunks comprised in the data stream D is parsed for recognition of bit patterns. For each unique bit pattern pₓ, that the parser comes across during the parsing process, an index bin bₓ, will be created. The elements of the index bin bₓ comprise, and are limited to, the indexes of all the chunks d originating from the data stream D that features the bit pattern pₓ.

In our example, as illustrated by FIG. 5, the pattern p₄ is found at indexes 0, 1 and 7, and hence, the index bin b₄ contains the indexes 0, 1 and 7. Further, the pattern p₅ is found at indexes 2 and 4, and therefore, after parsing, an index bin b₅ containing the indexes 2 and 4 will have been created.

In certain embodiments of the present invention, index bins for patterns that are not featured by any of the chunks in the data stream D are not created.

The predefined index table will now be used to calculate an index value sum Sₓ for each created index bin bₓ.

For each index i, comprised in an index bin bₓ, the corresponding index value Vᵢ will be retrieved from the index table. All the retrieved index values Vi are then added in an index value sum Sₓ.

For example, the index value sum S₄ resulting from the index bin b₄=[0, 1, 7] would be calculated as follows:

S₄=V₀+V₁+V₇=1+2+128=131

In embodiments where un-featured patterns are not represented by an index bin, its respective index value sum S may be set to 0.

In certain embodiments, the step of creating a bin of indexes may be omitted, and instead, for each found index, its associated index value Vᵢ is retrieved from the index table, and added to previously retrieved index values, such that the index value sum Sₓ is eventually achieved, in a piecemeal manner.

In a subsequent step, a list of index value sums is compiled, wherein the comprised index value sums are listed in a predefined listing order, such that the position in the list indicates the associated bit pattern pₓ. This predefined listing order of index value sums can also be considered as part of the common context.

The list of index value sums may now be transmitted from the first node 50 to the second node 60.

In alternative embodiments, where e.g. the compression-decompression methods are performed for the purpose of reducing required storage space in a single server, the list may now be stored in a local storage in the single server.

In order for a receiving node 60 to decompress a received list of index value sums, the index table that was used to create the received list must be present. Regardless of whether the decompression method 200 is performed in the same node that performed the compression, or in a second node 60, the decompression is performed in a similar fashion.

For each index value sum Sₓ in the list of index value sums received, its component indexes, i.e. the contents of a corresponding index bin bₓ, is retrieved as follows.

The underpinning principle of the decompressing method 200 is to compare a current value difference dV to index values in an iterative mode, and to select an index iₖ if its corresponding index value Vₖ is smaller than the current value difference dV. The current value difference dV is defined as the difference between a certain index value sum Sₓ and a sum of the index values associated with already selected indexes. Each time an index is selected, its associated index value is subtracted from the previously used current value sum to create a next current value sum.

To continue with the above example where S₄=131, initially no indexes are selected, and therefore, the initial current value difference dV=131−0=131.

As a next step we want to search the index table for the largest index value that is smaller than the current value difference.

In some embodiments, each index value in the table is compared to the current value difference dV, starting from the bottom of the table, i.e. where the largest-magnitude index value, the bottom index, is found.

In other embodiments, initially the largest index value that is smaller than the current value difference is found without prior comparison with the largest index value of the list.

In certain embodiments, this is accomplished through comparison of intervals between index values rather than index values per se.

In order to find the correct interval, comparison may be performed on an exponential factor of the index value or interval of index values. This improves the processing efficiency.

In our example, the largest index value of the table that is smaller than the current value difference, i.e. 131, is V₇=128, which corresponds to i=7. Therefore i=7 is selected as one component of the recreated index vector b₄

The next current value difference is 131−128=3. According to the table, the largest index value that is smaller than 3, is V₁=2. Hence, i=1 is selected, and added to the index bin b₄.

The next current value difference is 3−2=1. According to the table, the largest index value that is smaller than 2 is V₀=1, and hence i=0 is selected as a component of the index bin b₄.

As 1−1=0, the next current value difference equals zero. As no index value in the index table is smaller than the current value difference, it can be deducted that all components of the index vector has been found and selected.

The complete index bin b₄=[0, 1, 7] can now be recreated.

The above procedure is repeated at least for each index value sum Sₓ≠0 in the list of index value sums.

As the recreated index bins specify the bit pattern of each chunk comprised in the data stream D, the sequence of chunks of the data stream D can now be recomposed exactly as it was prior to partitioning in the first node.

The present methods are not limited to compressing data streams of bit length L. Larger bit streams may be divided into a multiple of bit streams D of bit length L. Each bit stream D of the multiple of data streams is then processed according to the above. This is an advantage as it enables e.g. parallel processing of multiple data streams D.

The methods of aspects of the invention may be performed in a network server adapted for serving and routing in a backbone network. Such a network server comprises processing and storing means, through which specific functions necessary for aspects of the invention may be implemented. These functions include but are not limited to a decomposing function, a partitioning function, a parsing function, a comparing and computing function, a selecting function, a bin creation and managing function, and a recreation function.

1. A method for compression of data within a common context providing a mapping of each index of a sequence of indexes to an index value, the method comprising the steps
decomposing a data set into a sequence of chunks, wherein each chunk is associated with a bit pattern and an index unique within the sequence;
and for a certain bit pattern:
creating a value sum of all index values mapped to each index of every chunk associated with the bit pattern.

2. The method according to claim 1, wherein each chunk is of a predetermined bit length.

3. The method according to claim 1, wherein the creating step is repeated for each bit pattern of a set of bit patterns.

4. The method according to claim 1 comprising the further step of compiling a list of value sums comprising each created value sum.

5. The method according to claim 1, being performed in a first network server and comprising the further step sending the value sum to a second network server.

6. A method for decompression within a common context providing mapping of each index of a sequence of indexes to an index value, the method comprising the steps
retrieving a value sum, associated with a certain bit pattern;
selecting a set of indexes, such that the sum of all index values mapped to indexes comprised in the selected set of indexes equals the retrieved index value sum; and
recomposing a sequence of chunks such that each chunk associated with a selected index of the set of indexes is further associated with the unique bit pattern.

7. The method according to claim 6, being performed in a second network server, and comprising the further step receiving the value sum from a first network server.

8. The method according to claim 6, wherein the retrieving, selecting and recomposing steps are repeated for each value sum of a list of value sums.

9. The method according to claim 6, wherein the selecting step comprises the further step selecting an index if its associated index value is smaller than a current value difference.

10. The method according to claim 6, wherein the selecting an index step is repeated for indexes in a bottom-to-top order.

11. The method according to claim 6, wherein the current value difference is equal to the difference between the retrieved index value sum and a sum of each associated index value of each previously selected index.

12. A method according to claim 1, wherein the common context provides mapping between an index and an index value, such that each index value is larger than a sum of all index values mapped to a subset of consecutive indexes comprising the top index and the upper adjacent index in the sequence of indexes.

13. A method according to claim 1, wherein an initiation of the common context comprises mapping indexes in increasing top-to bottom order.

14. A method according to claim 1, wherein the common context comprises a predefined listing order of value sums, such that the position of each value sum in the list indicates the associated bit pattern.

15. A computer program comprising code means for performing the steps of claim 1, when the program is run on a computer.

16. A computer program product comprising program code means stored on a computer readable medium for performing the method of claim 1, when said product is run on a computer.
